(19) United States
(12) Patent Application Publication
(10) Pub. No.: US 2015/0153208 A1
(43) Pub. Date: Jun. 4, 2015

(54) THERMAL, FLOW MEASURING DEVICE AND METHOD FOR OPERATING A THERMAL, FLOW MEASURING DEVICE

(71) Applicant: Endress + Hauser Flowtec AG, Reinach (CH)

(72) Inventors: Martin Arnold, Reinach (CH); Jan Schirrecker, Wintzenbach (FR); Axel Pfau, Aesch (CH)

(21) Appl. No.: 14/551,154

(22) Filed: Nov. 24, 2014

(30) Foreign Application Priority Data
Nov. 29, 2013 (DE) 10 2013 113 253.7

(51) Int. Cl. G01F 1/68

(52) U.S. Cl. CPC G01F 1/68

(57) ABSTRACT

A thermal, flow measuring device for determining and/or monitoring the flow of a measured medium through a measuring tube, including a first sleeve, especially a first metal sleeve, and at least a second sleeve, especially a second metal sleeve, a first temperature sensor element and at least a second temperature sensor element. At least the first temperature sensor element is heatable and arranged in the first sleeve and the second temperature sensor element is arranged in the second sleeve. The thermal, flow measuring device has a piezoelectric transducer unit, which causes at least one of the sleeves to vibrate, as well as a method for operating a thermal, flow measuring device.

The present invention relates to a thermal, flow measuring device as defined in the preamble of claim 1 and to a method for operating a thermal, flow measuring device.

Conventional, thermal, flow measuring devices use usually two temperature sensors, which are embodied as equally as possible. These sensors are arranged, most often, in pin-shaped, metal sleeves, so-called stingers, and are in thermal contact with the medium flowing through a measuring tube or through the pipeline.

To this point in time, mainly RTD elements with helically wound platinum wires have been used in thermal, flow measuring devices. In the case of thin-film-resistance thermometers (TFRTDs), conventionally, a meander-shaped platinum layer is vapor deposited on a substrate. Beyond that, another glass layer is applied for protecting the platinum layer. The cross section of the thin-film resistance thermometer is rectangular, in contrast with the RTD elements, which have a round cross section. The heat transfer into the resistance element and/or from the resistance element occurs accordingly via two oppositely lying surfaces, which together make up a large part of the total surface of a thin-film resistance thermometer.

During the measuring of the flow, thus of the mass flow, the flow velocity or the volume flow, by means of a thermal, flow measuring device, an accretion can build up on the surface of the metal sleeves, in which the temperature sensor elements are located. Also, through oxidative attack, corrosion, for instance in the form of pointwise corrosion or a corrosion layer, can develop. This leads to inaccuracies, respectively disturbances, in the flow measurement. In the case of gases, droplet formation, e.g. due to condensation on the metal sleeves, likewise can bring about a disturbance of the flow measurement.

An object of the invention is to provide an improved thermal, flow measuring device.

The present invention solves the aforementioned object by a thermal, flow measuring device having the features of claim 1.

A thermal, flow measuring device of the invention for determining and/or monitoring the flow of a measured medium through a measuring tube (2) includes a first sleeve, especially a first metal sleeve, and at least a second sleeve, especially a second metal sleeve, as well as a first temperature sensor element and at least a second temperature sensor element, wherein at least the first temperature sensor element is heatable and arranged in the first sleeve and the second temperature sensor element is arranged in the second sleeve, and wherein the thermal, flow measuring device further includes a piezoelectric transducer unit, which is suitable for causing at least one of the sleeves to vibrate.

The sleeves can especially be metal sleeves, which is preferable due to their simpler processability and adaptability to the rest of the sensor unit. The transition regions of the metal sleeve to the rest of sensor unit are, in such case, pressure resistant and sealed. Known are, however, also ceramics sleeves, which can basically be applied for the purpose.

Preferably, in such case, the piezoelectric transducer unit is coupled oscillation mechanically with the said metal sleeve. Thus, the piezoelectric transducer element can during operation of the thermal, flow measuring device cause one of the two metal sleeves to oscillate.

In the case of changes of vibrations of the metal sleeves, especially in the case of same medium and in the case of same flow velocity, such changes indicate an occurrence of deposits (accretion or droplets), corrosion or abrasive removal of material, i.e. that a disturbance has occurred.

Alternatively or supplementally, the piezoelectric transducer unit enables a cleaning, especially a cleaning of the flow measuring device in the installed state.

In such case, the piezoelectric transducer element is preferably mechanically, especially acoustically, coupled with the metal sleeve oscillation. In this way, vibrations of the transducer element can be transmitted to the metal sleeve. This can e.g. be achieved by making the sensor unit completely of metal, e.g. steel, especially stainless steel.

Advantageous embodiments of the invention are subject matter of the dependent claims.

The piezoelectric transducer unit or another piezoelectric transducer unit can register the vibration changes e.g. in the case of arising accretion and, in given cases with the aid of an evaluation unit, display such. This enables detection of accretion, corrosion or droplets.

The thermal, flow measuring device includes at least one sensor unit, wherein the piezoelectric transducer unit is associated with the sensor unit and wherein the flow measuring device has an operating mode for detecting accretion, corrosion and/or droplets on at least the one of the two metal sleeves, which is caused to vibrate by the transducer unit. In the case of this embodiment, the user is only informed of the occurrence of one of the aforementioned disturbances. Thereupon, the user can assess the reliability of the measuring.

Advantageous is when the thermal, flow measuring device has a sensor unit, wherein the sensor unit is associated with the piezoelectric transducer element and wherein the flow measuring device has an operating mode for determining a characteristic variable as a function of accretion, droplets and/or corrosion on at least the one of the two metal sleeves, which is caused to vibrate by the transducer unit. This variant has the advantage that the user can evaluate the scope of the disturbance. In this way, user is informed e.g. concerning the scope of a disturbance related to an accretion and can, based on the characteristic variable, detect how extensive the disturbance is.

Advantageously, the flow measuring device has an evaluation unit, which is embodied to correct the flow based on the ascertained characteristic variable. In this way, the aforementioned characteristic variable is utilized for correcting the measuring, respectively for compensating the measurement error and, thus, a corrected measured value is output.

Advantageously, the thermal, flow measuring device has an operating mode, which brings about a lessening of accretion, droplets or corrosion on the at least one vibrating metal sleeve.

Advantageously, the two metal sleeves are caused to vibrate by the transducer unit. In this way, the sensor unit can be embodied as a kind of oscillatory fork, especially an acoustic, oscillatory fork.

The thermal, flow measuring device can preferably have an operating mode, in which the flow measurement occurs and at least one additional operating mode, as set forth in one of the above embodiments and wherein the operating mode for flow measurement is executed when the other operating mode is not executed. This means that the operating modes, in which the metal sleeve is caused to vibrate and those in which the thermal flow measurement occurs, are separated in time from one another. Thus, an accretion recognizing can occur e.g. during measuring pauses of the thermal, flow measuring device. The temperature profile over the metal sleeve at flow measurement is not or only slightly altered by the vibrations.

The metal sleeves have, in each case, a longitudinal axis. They protrude from an end face of a sensor wall of the sensor unit. The transducer unit is arranged between the longitudinal axes and the separation of the transducer unit from each of the longitudinal axes is equally large. In this way, an equal exciting of the two metal sleeves is achieved. The same holds, of course, in the case of more than two metal sleeves, thus e.g. three or four metal sleeves.

The evaluation unit can be provided both for accretion recognition as well as also for flow measurement. In this way, a compact construction of the thermal, flow measuring device can be implemented.

The thermal, flow measuring device can be utilized for ascertaining the flow of a gas, wherein the flow measuring device additionally enables droplet recognition.

A method of the invention for operating a thermal, flow measuring device having a sensor unit includes at least one operating mode for determining flow, especially mass flow. The method includes additionally an operating mode for detecting accretion arising at least in certain regions of the sensor using excitation of the sensor unit to cause it to vibrate. In such case, it suffices, when the sensor unit is excited to vibrate only in certain regions.

The aforementioned method can preferably be carried out with a thermal, flow measuring device as described in one of the above embodiments.

The invention will now be explained in greater detail based on the appended drawing, the figures of which show as follows:

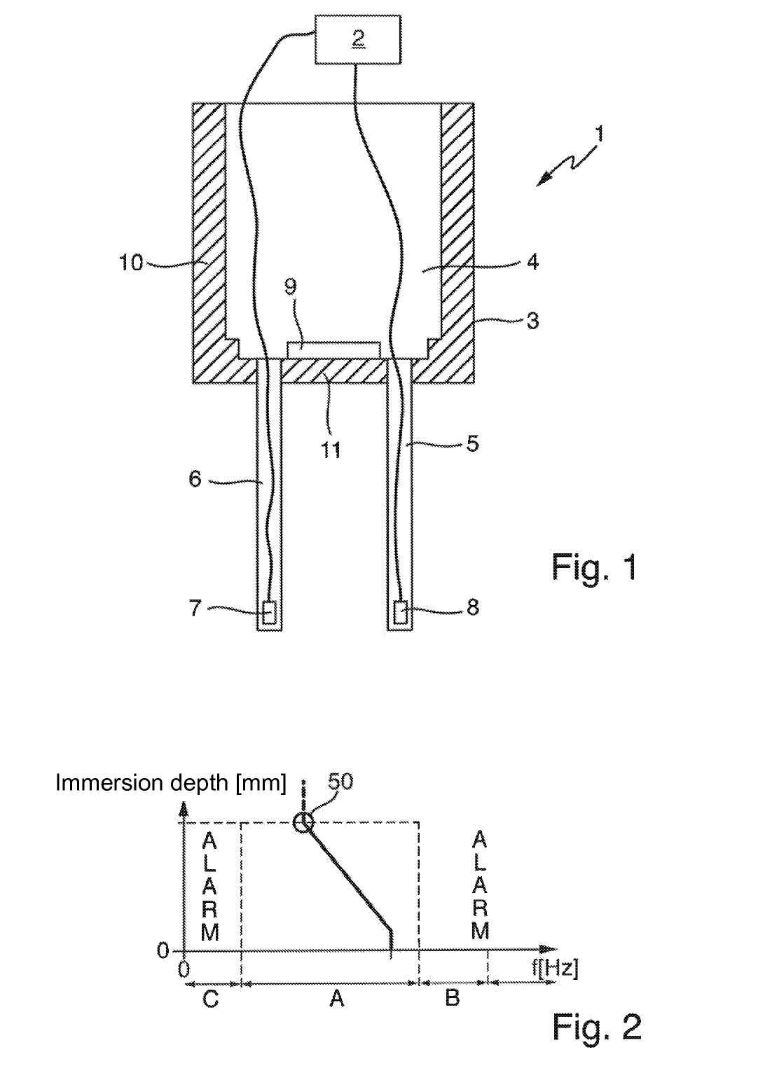

FIG. 1 a sectional view of a thermal, flow measuring device of the invention for ascertaining the flow of a measured medium;

FIG. 2 a graph of the relationship between frequency and immersion depth of the flow measuring device.

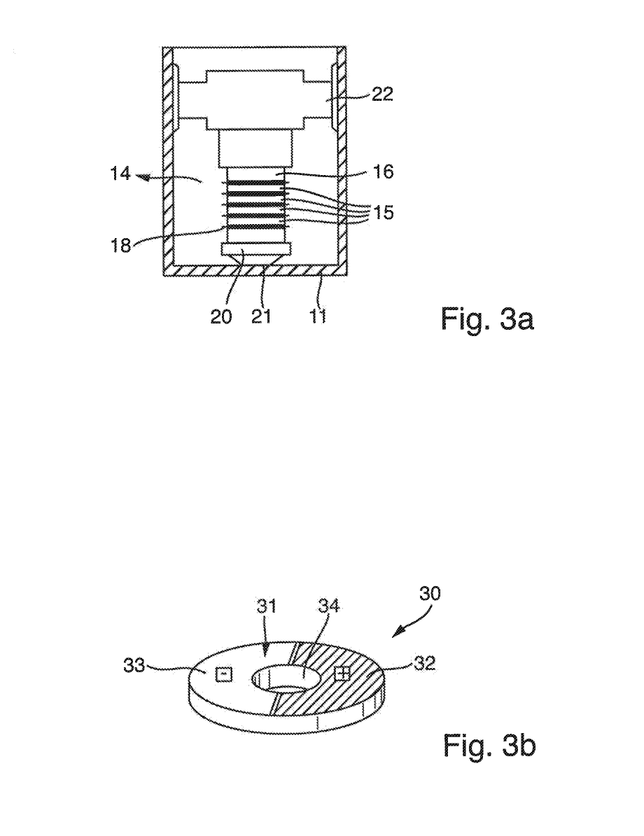

FIG. 3a a first variant of an embodiment of a piezoelement for producing oscillations;

FIG. 3b a second variant of an embodiment of a piezoelement for producing oscillations.

FIG. 1 shows a thermal, flow measuring device 1 of the invention in sectional view including a sensor unit 3 and a schematically illustrated evaluation unit 2. Evaluation unit 2 can simultaneously represent a control unit. Sensor unit 3 includes a sensor body 10 with a hollow space 4. Sensor unit 3 additionally includes a first metal sleeve 5 embodied as a pencil-shaped sleeve. Metal sleeve 5 protrudes from the sensor body 10.

Sensor unit 3 additionally includes a second metal sleeve 6, which likewise protrudes from the sensor body 10 and extends parallel to the first metal sleeve 5. Instead of metal sleeves 5 or 6, also ceramic sleeves can be utilized.

Preferably, sensor body 10 and metal sleeves 5, 6 are composed of a vibration conducting material. This can be a metal, preferably steel, especially stainless steel. In this way, an acoustic coupling of the individual components of the sensor unit 3 is achieved. Especially preferably, both the sensor body 10 as well as also the metal sleeves 5, 6 are of the same material.

Sensor body 10 includes between the first and second metal sleeves 5 and 6 an intermediate piece 11, which will be referred to below as a membrane.

Arranged in the region of this intermediate piece 11 within the hollow space 4 of the sensor unit 3 is at least one piezoelectric transducer unit 9. The metal sleeves 5 and 6 have longitudinal axes. The transducer unit 9 has equal separations from these longitudinal axes.

A piezoelectric transducer unit 9 can in a simple embodiment be a piezoelement. Preferred embodiments of transducer unit 9 are preferably constructed as shown in FIGS. 3a and 3b.

FIG. 3a shows a construction of a first embodiment of a transducer unit 14. In such case, of concern is a stack arrangement. Transducer unit 14 includes, in such case, a transducer housing 16. Transducer unit 14 rests between a fixed point 21 on the membrane 11 and a yoke 22, which bears against a shoulder, respectively a bearing region, of the transducer housing 16. Transducer unit 14 is embodied, in such case, as a monolithic block composed of disk shaped piezoelectric elements 15, disk shaped insulating elements 18, as well as the individual solder tabs. Transducer unit 14 rests, in such case, via a metal nose 20 on the membrane 11 and is prestressed between the membrane 11 and the yoke 22, wherein the membrane 11 in this construction serves preferably also as spring element. The construction of a sensor unit with such a transducer unit 14 requires, however, a high mechanical prestress in the piezo drive, respectively in the transducer unit 14, wherein the prestress is determined, for example, by a spring element, here in the form of the membrane 11. Care should ideally be taken that the membrane 11 and other securement elements, such as e.g. the yoke 22, are not mechanically overloaded. Should the mechanical stress in the affected parts exceed a yield point, metal parts become plastically deformed, which can make the sensor inoperable.

FIG. 3b shows a further example of an embodiment of a transducer unit 30. Transducer unit 30 has at least one outer surface 31, which is composed of at least two segments 32, 33 of different polarization. In such case, the polarization directions are preferably essentially opposite to one another, so that the mechanically oscillatable unit is excited to a movement, respectively so that a movement of the mechanically oscillatable transducer unit is obtained, wherein the movement brings about at least two different force components. FIG. 3b shows the piezoelectric transducer unit 30 in the form a round disk, whose outer surface 31 has the two segments 32, 33, whose polarizations are opposite to one another (here shown by plus + and minus −). For guiding cables, for example, the sensor cable of the two temperature sensing elements, or for affixing the element 30, an option is to provide one or more bores 34 in the disk. The fact that here and in the following the transducer units are treated as round should not be construed as limiting. The geometric embodiment of the piezo electrical transducer unit is subject to no limitation. It can thus also be in the form of e.g. polygonal washers and the like. It should only be assured that the mechanically oscillatable unit has at least two, differently polarized segments 32, 33, respectively provides different force components. A stack of two of the piezoelectric transducer units 30 illustrated in FIG. 3 can also excite a single metal sleeve 5 or 6 directly to sawtooth oscillations.

In an additional embodiment, the outer surface of a piezo electrical transducer unit can be divided into four segments. The polarizations of the segments, respectively their force components to be produced and to be received, are, in each case, identical. The polarizations, respectively the force components, of neighboring segments alternate. Also other embodiments of a piezoelectric transducer unit are possible, as well as the stacking of a plurality of these transducer units on top of one another.

Other structural variants of a transducer unit and their positioning in a sensor element are set forth in DE 10 2008 043 764 A1 and DE 102 60 088 A1. These documents concern, however, primarily the ascertaining of a fill level or limit level.

The sensor unit 3 shown in FIG. 1 serves primarily for ascertaining a flow velocity, or a mass or volume flow. For this, temperature sensor elements 7, 8 are arranged in the metal sleeves 5 or 6, preferably at their distal ends.

The operation of a thermal, flow measuring device, is basically known and will now be described in greater detail based on the example of an embodiment shown in FIG. 1.

The thermal, flow measuring device 1 uses two temperature sensor elements, which are preferably in the form of heatable resistance thermometers 7 and 8 embodied as equally as possible, and which are arranged in the pin-shaped metal sleeves 5 or 6, the so-called stingers. Thus, the temperature sensor elements are in thermal contact with the medium flowing through a measuring tube or through the pipeline. For industrial application, the metal sleeves 5 or 6 extend into a measuring tube; the resistance thermometer can, however, also be mounted directly in a pipeline. One of the two resistance thermometers 5 or 6 is a so-called active sensor element, which is heated by means of a heating unit. Provided as heating unit is either an additional resistance heater or the resistance thermometer is a resistance element, e.g. an RTD (Resistance Temperature Device) sensor, which is heated by converting electrical power, e.g. by a corresponding variation of the measuring electrical current. The second resistance thermometer 7 or 8 is a so-called passive sensor element: It measures the temperature of the medium.

Usually in a thermal, flow measuring device, a heatable resistance thermometer 7 or 8 is so heated that a fixed temperature difference is maintained between the two resistance thermometers. Alternatively, it is also known to supply a constant heating power via a control unit.

If there is no flow in the measuring tube, then an amount of heat constant over time is required for maintaining the predetermined temperature difference. If is, in contrast, the medium to be measured is moving, the cooling of the heated resistance thermometer depends essentially on the mass flow of the medium flowing past. Since the medium is colder than the heated resistance thermometer, the flowing medium transports heat away from the heated resistance thermometer. In order thus to maintain the fixed temperature difference between the two resistance thermometers in the case of a flowing medium, an increased heating power is required for the heated resistance thermometer. The increased heating power is a measure for the mass flow of the medium through the pipeline.

If, in contrast, a constant heating power is fed, then the temperature difference between the two resistance thermometers decreases as a result of the flow of the medium. The particular temperature difference is then a measure for the mass flow of the medium through the pipeline, respectively through the measuring tube.

There is, thus, a functional relationship between the heating energy needed for heating the resistance thermometer 7 or 8 and the mass flow through a pipeline, respectively through a measuring tube. The dependence of the heat transfer coefficient on the mass flow of the medium through the measuring tube, respectively through the pipeline, is utilized in thermal, flow measuring devices especially for determining the mass flow. Devices, which operate according to this principle, are manufactured and sold by the applicant under the marks, ‘t-switch’, ‘t-trend’ and ‘t-mass’.

An especially preferred arrangement of passive and active sensor elements in metal sleeves is described in DE 10 2008 01 53 59 A1, to the disclosure of which comprehensive reference is taken in the context of the present invention.

The thermal, flow measuring device 1 schematically shown in FIG. 1 includes additionally a control and/or evaluation unit 2. This can be utilized for operating the piezoelectric transducer element 9 as well as also for operating the temperature sensors. It is, however, also an option that the individual elements are operated by a plurality of control and evaluating units.

The way in which the thermal, flow measuring device illustrated in FIG. 1 works will now be explained in greater detail with the aid of FIG. 2.

As already explained above, mass flow can be ascertained by the sensor unit, respectively by the two temperature sensor elements 7 and 8.

The measuring can, however, be disturbed by accretion formation or, in the case of gas measurements, by droplet formation.

In a preferred embodiment of the invention, an operating mode for accretion recognition can be entered. The metal sleeves are caused to oscillate by an exciter signal emitted by the piezoelectric transducer unit. The oscillation is damped, or attenuated, as a function of the medium. The transducer unit receives a received signal as a function of the attenuation. The difference between the exciter signal and the received signal provides information concerning the size of the damping.

The behavior of the thermal, flow measuring device upon the occurrence of an accretion is illustrated in FIG. 2.

FIG. 2 shows the dependence of resonant frequency of the oscillatory system on the fill level of the tube. The determining of fill level is, in such case, only an optional variant for liquid media. For gaseous media, the ascertaining of fill level is not necessary. The resonant frequency at the measuring point 50 is the resonant frequency in the case of filled pipe.

The acceptable region A of the characteristic frequency, respectively the resonant frequency, lies preferably in the range between 200 and 3000 Hz, especially preferably, however, between 400 and 1900 Hz. Upon exceeding or subceeding the limit values of the frequency range of the characteristic frequency, then an alarm can occur, which indicates accretion, corrosion, droplets or an abrasive removal of material. An exceeding suggests loss of mass, while, in contrast, a subceeding indicates an increase of mass.

To the extent that accretion or corrosion has occurred on the metal sleeves, the oscillation of the metal sleeves, respectively of the oscillatory system, is attenuated. The characteristic frequency, respectively the resonant frequency, of the oscillatory system as received signal exceeds, in this case, an upper desired value. This exceeding of the upper desired value and therewith a drift of the resonant frequency into the region B indicates a negative mass change on the metal sleeves e.g. because of abrasion. This position shifting of the resonant frequency is referred to as frequency drift.

Also a positive mass change of the metal sleeves e.g. because of accretion, droplets or corrosion on the metal sleeve, can be recognized. In such case, a lower desired value is subceeded and the drift shifts the resonant frequency into the region C.

In an additional preferred embodiment of an operating mode, the shifting of the characteristic frequency, respectively the resonance frequency drift, e.g. in the case of occurrence of accretion, can be ascertained. This value can be utilized at least for partial compensation of the measurement error of the flow measurement brought about by the accretion/corrosion, droplet formation or material removal on the metal sleeves.

In an additional preferred embodiment of an operating mode, a cleaning of the metal sleeves can occur. When the transducer unit is supplied with a very high excitation frequency, then the vibrations of the metal sleeves increase. Liquid cavitation effects occur, whereby a cleaning of the metal sleeves of deposits is enabled. In the case of use of the flow measuring device for measuring gases with a tendency for droplet formation, these droplets can be shaken off by the vibrations.

The three aforementioned embodiments can be advantageously combined, respectively integrated, into a flow measuring device, individually or together with one another, as other operating modes of the flow measuring device. The operating modes can preferably be controlled by the control and/or evaluation unit.

The vibrations of the metal sleeves can, however, disturb the temperature profile of the medium over the temperature sensor, respectively the metal sleeves. In an especially preferred embodiment, the flow measuring device can have at least two operating modes. A first operating mode comprises the flow measurement of the medium. A second operating mode comprises the accretion recognizing, the ascertaining of the disturbance from the accretion and the compensating of the ascertained flow measured values and/or the cleaning the metal sleeves.

The flow measuring device switches between the two accretion modes. Thus, the flow measurement is not or only little disturbed by the vibrations of the metal sleeves.

The flow measuring device can have other operating modes, in which the oscillations of the metal sleeves can serve for improving the measuring performance. Thus e.g. a detecting of a change in the medium or of a viscosity can occur.

The metal sleeves of the sensor unit can be embodied in various ways. Thus, an option is, for example, to provide the sleeves with lateral wings, so that the metal sleeves have a plate-shaped outer contour. Such contours are known from the field of fill level measurement.

The frequency range of the characteristic frequency, respectively the resonant frequency, lies preferably in the range between 200 and 3000 Hz, especially preferably, however, between 400 and 1900 Hz. In the case of exceeding or subceeding the limit values of the frequency range of the characteristic frequency, then an alarm can occur, which indicates accretion, corrosion, droplets or abrasive removal of material.

### LIST OF REFERENCE CHARACTERS

1 thermal, flow measuring device
2 evaluation unit
3 sensor unit
4 hollow space
5 first metal sleeve
6 second metal sleeve
7 first temperature sensor element
8 second temperature sensor element
9 transducer unit
10 sensor body
11 intermediate piece/membrane
14 transducer unit
15 piezoelectric element
16 transducer housing
18 insulating elements
20 nose
21 fixed point
22 yoke
30 transducer unit
31 outer surface
32 first piezoelectric segment
33 second piezoelectric segment
50 characteristic frequency/resonant frequency at fully filled measuring tube
A acceptable resonance frequency range
B region above the acceptable resonance frequency range (mass loss on the metal sleeve)
C region below the acceptable resonance frequency range (mass increase on the metal sleeve)

1-12. (canceled)

13. A thermal, flow measuring device for determining and/or monitoring the flow of a measured medium through a measuring tube, comprising:
a first sleeve, especially a first metal sleeve;
at least a second sleeve, especially a second metal sleeve;
a first temperature sensor element; and
at least a second temperature sensor element,
a piezoelectric transducer unit, which is suitable for causing at least one of said sleeves to vibrate, wherein:
at least said first temperature sensor element is heatable and arranged in said first sleeve and said second temperature sensor element is arranged in said second sleeve.

14. The thermal, flow measuring device as claimed in claim 13, wherein:
said piezoelectric transducer unit said at least one other piezoelectric transducer unit is provided for registering changes of vibratory behavior in the case of a mass change on said sleeves, especially the metal sleeves.

15. The thermal, flow measuring device, as claimed in claim 13, further comprising:
at least one sensor unit, wherein:
said piezoelectric transducer unit is associated with said sensor unit and the flow measuring device has an operating mode for detecting deposit, corrosion and/or droplets on at least the one of said two sleeves, which is caused to vibrate by said transducer unit.

16. The thermal, flow measuring device as claimed in claim 13, further comprising:
a sensor unit, wherein:
said piezoelectric transducer element is associated with said sensor unit; and
the flow measuring device has an operating mode for determining a characteristic variable as a function of accretion, droplets and/or corrosion on at least the one of said two sleeves, which is caused to vibrate by said transducer unit.

17. The thermal, flow measuring device as claimed in claim 16, further comprising:
an evaluation unit, which is embodied to correct the flow based on the ascertained characteristic variable.

18. The thermal, flow measuring device as claimed in claim 13, wherein:
both sleeves are caused to vibrate by said transducer unit.

19. The thermal, flow measuring device as claimed in claim 13, wherein:
the thermal, flow measuring device has an operating mode, in which the flow measurement occurs, and at least one additional operating mode; and
the operating mode for flow measurement is executed when the other operating mode is not executed.

20. The thermal, flow measuring device as claimed in claim 13, wherein:
said sleeves have, in each case, a longitudinal axis and protrude from an end face of a sensor wall of said sensor unit; and
said transducer unit is arranged between the longitudinal axes and the separation of said transducer unit from each of the longitudinal axes is equally large.

21. The thermal, flow measuring device as claimed in claim 17, wherein:
said evaluation unit is provided both for accretion recognition as well as also for flow measurement.

22. The use of the thermal, flow measuring device as claimed in claim 13 for ascertaining the flow of a gas, wherein:
the flow measuring device additionally enables droplet recognition.

23. A method for operating a thermal, flow measuring device having a sensor unit, comprising the steps of:
providing at least one operating mode for determining flow, especially mass flow; and
an operating mode for detecting accretion arising at least in certain regions of the sensor unit using excitation of the sensor unit to cause it to vibrate.

24. The method as claimed in claim 23, wherein:
a thermal, flow measuring device is operated.
